(19) United States
(12) Patent Application Publication
(10) Pub. No.: US 2026/0125515 A1
(43) Pub. Date: May 7, 2026

(54) ELECTRON BEAM IRRADIATION OF BLENDS OF PARTIALLY CROSS-LINKABLE AND DEGRADABLE POLYMERS FOR THE FORMATION OF FLOWABLE BLENDS WITH ENHANCED MECHANICAL PROPERTIES

(71) Applicant: THE ZOMMER FOUNDATION, Davie, FL (US)

(72) Inventors: Shmuel Kenig, Tel Aviv (IL); Hanna Dodiuk, Haifa (IL); Nathan Zommer, Davie, FL (US)

(21) Appl. No.: 19/368,147

(22) Filed: Oct. 24, 2025

Related U.S. Application Data
(60) Provisional application No. 63/716,041, filed on Nov. 4, 2024.

(51) Int. Cl. C08J 3/00; C08J 3/28; C08L 23/06

(52) U.S. Cl. CPC C08J 3/005; C08J 3/28; C08L 23/06; C08J 2323/06; C08L 2205/025; C08L 2207/066; C08L 2207/20

(57) ABSTRACT

Electron beam irradiation (at a total dose of up to 50 kGy) is used to degrade and partially cross-link a blend of recycled polyethylene (PE) (for example, LDPE) obtained at least in part from used articles and recycled polypropylene (PP) obtained at least in part from used articles (and optionally also recycled polyethylene terephthalate (rPET)) to create a new complex partially cross-linked “Super PE” material. The Super PE material is less than 30% PP. Importantly, the Super PE material is flowable and has a complex viscosity CV of less than or equal to 6000 Pa·s@230° C. at 1 Hz, while also exhibiting a modulus of elasticity E of a least 300 MPa, an ultimate stress at failure 6 of at least 15 MPa, and an ultimate strain at failure E of at least 600%. The material is pelletized, and then sold for use in making new articles.

### CROSS REFERENCE TO RELATED APPLICATION

This application claims the benefit under 35 U.S.C. § 119 (e) from U.S. Provisional Application No. 63/716,041, entitled “Electron Beam Radiation Of Blends Of Partially Cross-Linkable And Degradable Polymers For The Formation Of Flowable Blends With Enhanced Mechanical Properties,” filed on Nov. 4, 2024, by Shmuel Kenig, et al. The entirety of the disclosure of the foregoing document is incorporated herein by reference.

### TECHNICAL FIELD

The present invention relates generally to the field of partially cross-linked polymers made from blends of polymers, and more particularly to partially cross-linked polymers made from recycled used plastic articles.

### BACKGROUND INFORMATION

The world is facing a major environmental problem due to the annual increase in Plastic Waste (PW). The PW is composed mainly of Polyethylene (PE), Polypropylene (PP), Polyethylene terephthalate (PET), and other materials. This PW is in the form of plastic bags, plastic bottles, plastic enclosures, packages, electronic equipment, appliances, car parts, etc. There is a trend to recycle this waste. In most cases, the PW is processed by mechanical methods, to produce small pellets of said material, to be reprocessed back as the same material, or burned as fuel.

### SUMMARY

Electron Beam Irradiation (EBI) of up to 50 kGy is used to partially cross-link Low-Density Polyethylene (LDPE), Polypropylene (PP), and recycled Polyethylene Terephthalate (rPET) blends at different compositions. Their subsequent mechanical and rheological properties have been investigated with the aim of developing an innovative method to upcycle the properties of post-consumer resins (PCRs) while maintaining their processability. It was concluded that PP (degraded by EBI) when blended with PE or rPET, exhibited optimal mechanical and rheological properties.

Unexpectedly, it was found that in order to obtain a processable PCR, a degradable polymer (degraded by the effect of EBI) should be included, while the other constituents should be cross-linkable by the EBI. Thus, the addition of 20 wt. % LDPE to PP (degraded by EBI) and irradiation to 25 kGy decreases the complex viscosity (CV) by almost ten-fold (measured at 1 Hz at 230° C.), and the addition of 20 wt. % of rPET to PP and irradiation to 25 and 50 kGy decreases CV by a factor of 4 to 5 respectively (measured at 1 Hz at 290° C.). In one example, the addition of PP (degraded by EBI), when blended with LDPE or rPET, should be limited in weight percent and irradiation dose to achieve optimal mechanical properties. Hence, the EBI of PP/rPET 50/50 and 80/20 blends were too brittle to process into 0.5 mm sheets. However, blends of PP/LDPE of the same ratios were not. By comparison, neat PP irradiated to 50 kGy was too brittle to form into 0.5 mm sheets. Scanning electron and optical microscopies showed that phase separation of the incompatible PE, PP, and PET phases when blended, decreased after EBI and subsequent processing.

In conclusion, polymer blend ratio and irradiation dose are the decisive factors in changing the mechanical properties and rheological behavior of PCR blends composed of balanced cross-linkable and degradable constituents. Consequently, controlled EBI of PCR blends leads to optimal and enhanced mechanical properties with processable viscosities and improved blend compatibility. Optimal compounding composition of incompatible PCR blends followed by pelletizing and controlled EBI leads to the production of upcycled PCR blend pellets and presents an economical and facile route to a circular economy of commodity resins.

In one novel aspect, an amount of PE material is obtained at least in part from previously used articles (i.e., articles to be recycled). This amount of material, referred to as PE material, may actually include small amounts of other materials as is commonly found in recycled articles made primarily of PE. The PE in the PE materials may be largely LDPE or HDPE. Also, an amount of PP is separately obtained in a separate step at least in part from previously used articles. This amount of material, referred to as PP material, may actually include small amounts of other materials as is commonly found in recycled articles made primarily of PP. A ratio of the amounts of PE and PP materials (for example, an 80% PE and 20% PP ratio) is then combined into a composite material, for example, by passing the amounts through an extruder. The resulting composite material (either in the melt state or in the solid state) is then irradiated with electron beam radiation (for example, at a dose of 50 kGy) so as to promote degradation and cross-linking. The resulting “Super PE” material, is in pellet form. The pelletized Super PE material may then be sold in pelletized form for subsequent use in making plastic articles. In one novel aspect, a novel material referred to as “Super PE” material is the complex partially cross-linked material that results from e-beam irradiating (for example, at a dose of 50 kGy) a blend of PP (≤30% by weight in the starting material) and PE (≤90% by weight in the starting material), where the blend that is irradiated comprises substantially no compatibilizer, and is at least 95% by weight a combination of PP and PE. Importantly, the new partially cross-linked “Super PE” material is flowable and has a complex viscosity CV of less than or equal to 6000 Pa·s@230° C. at 1 Hz, while also exhibiting a modulus of elasticity E of a least 300 MPa, an ultimate stress at failure 6 of at least 15 MPa, and an ultimate strain at failure E of at least 600%. In one example, ≤30% by weight of the final Super PE material is PP and the gel content is lower than 40%. In another example, ≤30% by weight of the final Super PE material is PP and the gel content is lower than 20%.

In another novel aspect, an amount of PET material is obtained at least in part from previously used articles (i.e., articles to be recycled). This amount of material, referred to as PET material, may actually include small amounts of other materials as is commonly found in recycled articles made primarily of PET. Also, an amount of PP is obtained at least in part from previously used articles. This amount of material, referred to as PP material, may actually include small amounts of other materials as is commonly found in recycled articles made primarily of PP. A ratio of the amounts of PET and PP materials (for example, 80% PET and 20% PP ratio) is combined into a composite material, for example, by passing the amounts through an extruder. The resulting composite material (either in the melt state or in the solid state) is then irradiated with electron beam radiation (for example, at a dose of 50 kGy) so as to promote degradation and cross-linking. The resulting “Super PP” material, is pelletized. The pelletized Super PP material may then be sold in pelletized form for subsequent use in making plastic articles.

In another novel aspect, a novel material referred to as “Super PP” material is the complex partially cross-linked material that results from e-beam irradiating (for example, at a dose of 50 kGy) a blend of PP (≤30% by weight in the starting material) and PET (≤90% by weight in the starting material), where the blend that is irradiated comprises substantially no compatibilizer, and is at least 95% by weight a combination of PP and PET. Importantly, the new partially cross-linked “Super PP” material is flowable and has a complex viscosity CV of less than or equal to 30 Pas@290° C. at 1 Hz, while also exhibiting a modulus of elasticity E of at least 2300 MPa, an ultimate stress at failure 6 of at least 30 MPa, and an ultimate strain at failure E of at least 30%. In one example, ≤30% by weight of the final Super PP material is PP.

In another novel aspect, an amount of PET material is obtained at least in part from previously used articles (i.e., articles to be recycled). This amount of material, referred to as PET material, may actually include small amounts of other materials as is commonly found in recycled articles made primarily of PET. Also, an amount of PP is obtained at least in part from previously used articles. This amount of material, referred to as PP material, may actually include small amounts of other materials as is commonly found in recycled articles made primarily of PP. A ratio of the amounts of PET and PP materials (for example, an 80% PET and 20% PP ratio) is combined into a composite material, for example, by passing the amounts through an extruder. The resulting composite material (either in the melt state or in the solid state) is then irradiated with electron beam radiation (for example, at a dose of 50 kGy) so as to promote degradation and cross-linking. The resulting “Super PP” material, is pelletized. The pelletized Super PP material may then be sold in pelletized form for subsequent use in making plastic articles.

In another novel aspect, a novel material referred to as “Super PP” material is the complex partially cross-linked material that results from e-beam irradiating (for example, at a dose of 50 kGy) a blend of PP (≤30% by weight in the starting material) and PET (≤90% by weight in the starting material), where the blend that is irradiated comprises substantially no compatibilizer, and is at least 95% by weight a combination of PP and PET. Importantly, the new partially cross-linked “Super PP” material is flowable and has a complex viscosity CV of less than or equal to 30 Pas@290° C. at 1 Hz, while also exhibiting a modulus of elasticity E of a least 2300 MPa, an ultimate stress at failure 6 of at least 30 MPa, and an ultimate strain at failure E of at least 30%. In one example, ≤30% by weight of the final Super PP material is PP.

Further details and embodiments and methods and techniques are described in the detailed description below. This summary does not purport to define the invention. The invention is defined by the claims.

### DESCRIPTION OF THE DRAWINGS

The foregoing and other objects of the present disclosure, the various features thereof, as well as the disclosure itself may be more fully understood from the following description, when read together with the accompanying drawings):

FIG. 1 is a diagram of a traditional cathode ray tube (CRT).

FIG. 2 is an illustration of a high-energy (HE) electron beam reactor.

FIG. 3 is a diagram of the molecular structure of simple pure polyethylene.

FIG. 4 is a diagram of the molecular structure of polypropylene (PP).

FIG. 5 are images of the sample D100 of the material of Example 1.

FIG. 6 are images of the same material as that of Example 1, except that the material of FIG. 6 was not irradiated with electron beam radiation.

FIG. 7 is a diagram of the molecular structure of Polyethylene Terephthalate (PET).

### DETAILED DESCRIPTION

A method for processing PW is disclosed that uses High Energy (HE) electrons, to create a higher value added (HVA) material with better properties than the original starting materials. The HE electrons are generated by electron guns, that produce electron beams, (EB). EB technology is a known technology. It has been used to generate X-Rays. It is the core of several types of known laboratory equipment, like electron microscopes, electron tubes, CRT's that have been our televisions until the mid-1990's. For the presently disclosed method, however, we focus on EB technology that generates HE electrons in atmospheric pressure, originating from a vacuum based electron gun, from which the electrons are shot through a metal window, to hit the subjected material that is in atmospheric pressure.

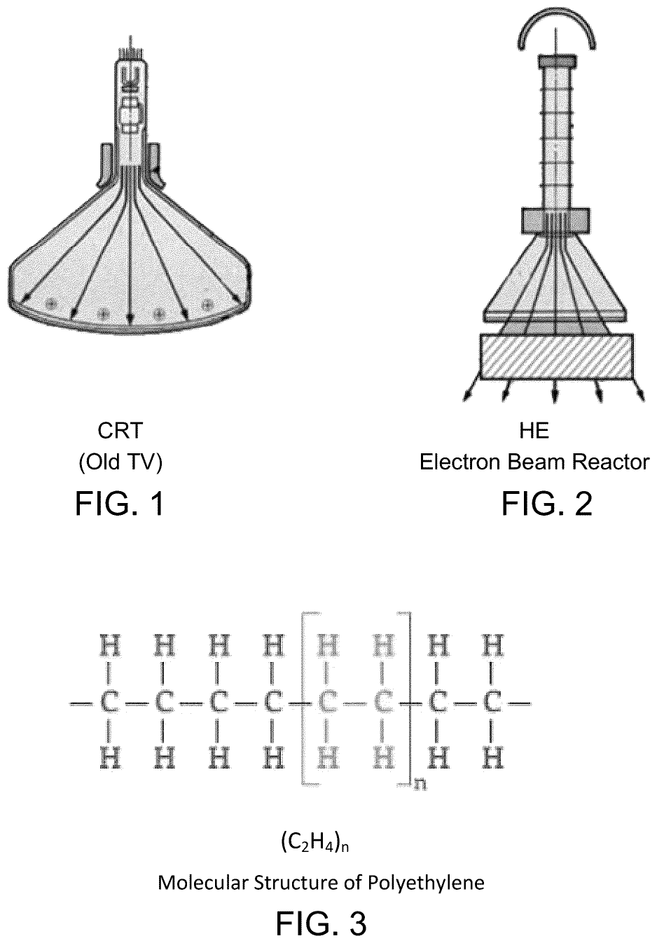

FIG. 1 is an illustration of a traditional cathode ray tube (CRT) that employs a beam of electrons.

FIG. 2 is an illustration of a high energy (HE) electron beam reactor. A process and a technology is disclosed that uses high energy electron beam technology to causes a new class of chemical reactions, induced by HE electrons, that effect a unique “upcycling” process, that when applied to the PW create a new desired polymer material. It is known to persons trained in the art that HE electrons can break the covalent bonds in say PE, or rubber, and create radicals, that can then in subsequent processing form cross-linking reactions, by which new chemical bonds are formed, and thus the PE or rubber becomes a stronger polymer or material. Some polymers, however, suffer degradation under such EB treatment, and become brittle or a weaker polymer material.

In a method taught here, standard polymers are taken as starting materials. These well-known polymer after use become PW and are then typically recycled. However the same method can be used with the virgin forms of these polymers. The core idea is in the process of recycling to focus on “upcycling”, namely to create a better polymer from the PW, or the original polymers that are the raw material in the taught process. The HE EB treatment enables new chemical synthesis that is not possible with other known chemical processes. The EB breaks covalent chemical bonds in the polymers. There are carbon to carbon, carbon to oxygen, carbon to nitrogen, and other bonds in the polymer molecules. When the covalent bonds are broken by the HE electrons, free radicals are created. These radicals are energized and activated by the electron beam, and are ready to create new bonds. By blending or mixing at least two different polymers, and then subjecting the blend to electron beam radiation, based on the methods in this disclosure, and by way of creating the above-described new bonds, a new polymer is created that has qualities superior to any one of the original starting polymers.

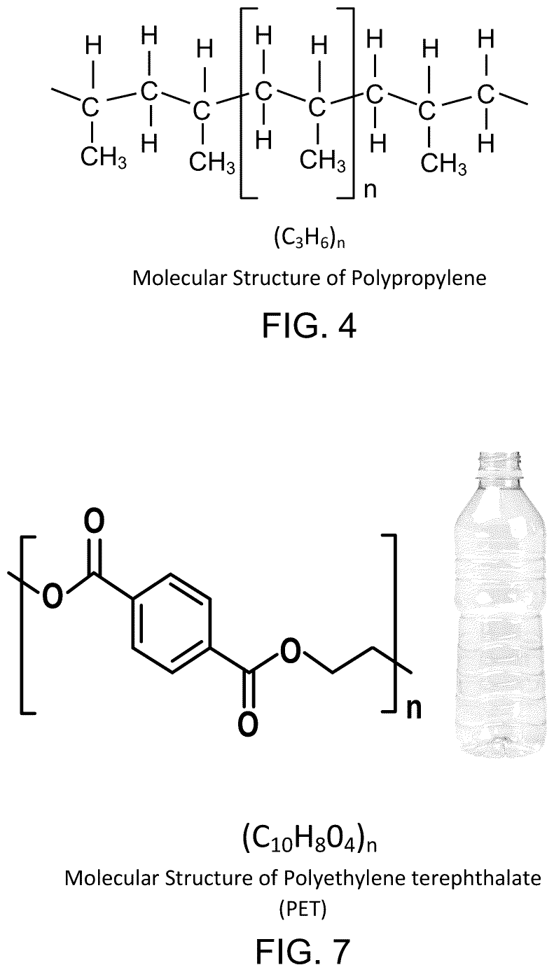

In one example, a blend of Polyethylene (PE) and Polypropylene (PP) is formed. FIG. 3 is a diagram of the molecular structure of simple pure polyethylene. FIG. 4 is a diagram of the molecular structure of simple pure polypropylene (PP). These two polymers are the most common polymers used presently, and form the majority of the PW. Thus it is a clear focus for this patent document to teach how these PW can be “upcycled” in accordance with a novel method. Namely, not just to recycle as PE or PP for use, but rather to create a new class of polymer, with better qualities than PE and PP. It is known that PE can go through cross-linking under EB treatment, namely further polymerization of the PE chains. However, PP is known to go through degradation under EB treatments, due to the breaking of the bonds within the polymer chain, namely scission of the chains. The reason PP goes through degradation, is the tertiary carbon, part of the CH₃, of the main chain. This tertiary carbon is illustrated in FIG. 4.

Selecting an EB energy above 150 Kev and up to 10 Mev is effective in creating the desired activity in the plastic material. There should be sufficient energy to penetrate the material. One can use the teaching of this patent document, with an EB of higher energy up to 10Mev for shorter beam treatment and higher production rates, in a commercial application. The processes and method described here use an EB reactor with an accelerating energy of 2 to 3.5 Mev. PP is known to go through material degradation under the EB irradiation. PE, however, goes through cross-linking (CL), namely some chemical bonds in the polymer chain get broken, but immediately get re-bonded in a different pattern to create the said cross-linking. The cross linking often results in a stronger material, referred to here a cross-linked PE, that is a stronger polymer than the original “native” PE.

The novel method taught in this patent document can be applied also to blends of more than two polymers, where one of the polymers is caused to go through material degradation while the others are made to go through cross-linking under EB irradiation. For example, the novel method can be applied to four polymers of different types, A, B, C, and D, where polymers A and B are made to go through degradation, and where polymers C and D made to go through cross-linking. The result is a new polymer material referred to as “ABCD” that exhibits different and desired properties that are different than those of the individual starting polymers A, B, C and D. Of particular environment protection interest, and sustainable economy, is to have the multiple starting polymers selected from waste polymer material PW, in order to ‘recycle’ them using the presently disclosed novel method, in order to create value added polymer materials, in a concept that referred to here as “upcycling.” One trained in the art, can apply the presently disclosed novel method to a multitude of polymer blends, more than two, with the practical limit of the blends, based on the availability of the polymers. Of added interest is also to apply this methodology to Polyethylene Terephthalate (PET) because it is a common plastic waste (PW) material from plastic bottles, mainly from the bottled water and food packaging industry.

The “Super PE” and “Super PP” blends result from the synthesis of new molecular structures in the irradiated polymers. As the degradable polymer in the blend degrades under EBI, it forms low molecular weight radicals. These radicals statistically meet a cross-linkable radical polymer, forming new covalent bonds. Thus, a grafted form of cross-linked new polymer is created, having enhanced properties (Super polymers) combining the crosslinking effect of the cross-linkable polymer and the grafting of the degradable polymer

The presently disclosed upcycling method can be applied also to ‘virgin’ polymers, not only from recycled waste sources. It can apply to a mixture, or a blend of, new ‘virgin’ produced polymers along with recycled sourced polymers. Similarly, the novel upcycling method is suitable to strengthen a blend of polymers that are produced from non-petroleum based or sourced polymers, like polymers from plants, dairy, wood, marine plants and other type of organic materials or waste. The methods taught in this patent document can apply to produce all the forms of polymers for industrial, medical, aerospace applications where the polymer is in the form of pellets, fibers, wires, sheets, tubes, noodles, gel, paste etc.

The upcycling method disclosed can apply to producing not only improved material qualities of polymers but also to producing in situ unique colors of the resultant polymer, based on the composition of said blends of polymers. It is of particular interest to produce polymers that will be durable in harsh conditions, stand up to UV irradiation of the sun, with added corrosive resistance against harsh chemicals, and with colors that do not fade in time. All these, can be achieved by selecting the proper blends of polymers, with the methods taught in this invention.

Example 1: A Blend was Made of 80% by Weight Low-Density polyethylene (LDPE) pellets (“IPETHENE 600” pellets manufactured by Carmel Olefins) and 20% by weight polypropylene (PP) pellets (“CAPILENE E50E” pellets manufactured by Carmel Olefins).

Importantly, there was substantially no (approximately zero percent by weight) intentionally added compatibilizer in the blend. The term compatibilizer as it is used here means an additive that makes incompatible polymers compatible. Such a compatibilizer has reactive groups on either end of the polymer chain that react with the different incompatible polymers. Compatibilizers are used to improve the compatibility of immiscible polymers and thus improve the morphology and resulting properties of the blend. Compatibilizers are also known as “Linking Materials” or “Compatibilization Agents”.

The 80/20 LDPE/PP ratio combination was processed through an extruder having a flat die, thereby yielding a 0.5 mm thick sheet of extruded polymer material. The 0.5 mm thick sheet (in its solid state) was then irradiated with electron beam radiation at a dose of 50 kGy (5MRad). After irradiation, the material was heated and then cooled to room temperature under pressure. Specimens (including sample D100) were then cut from the resulting sheet, and were tested. Results of the testing are set forth below.

EXAMPLE 1

| CV (Complex Viscosity) | 6000 Pa · s@230° C. at 1 Hz |
|---|---|
| E (Modulus of Elasticity) | 320 MPa |
| [symbol] (Ultimate Stress at Failure) | 15 MPa |
| [symbol] (Ultimate Strain at Failure) | 600% |

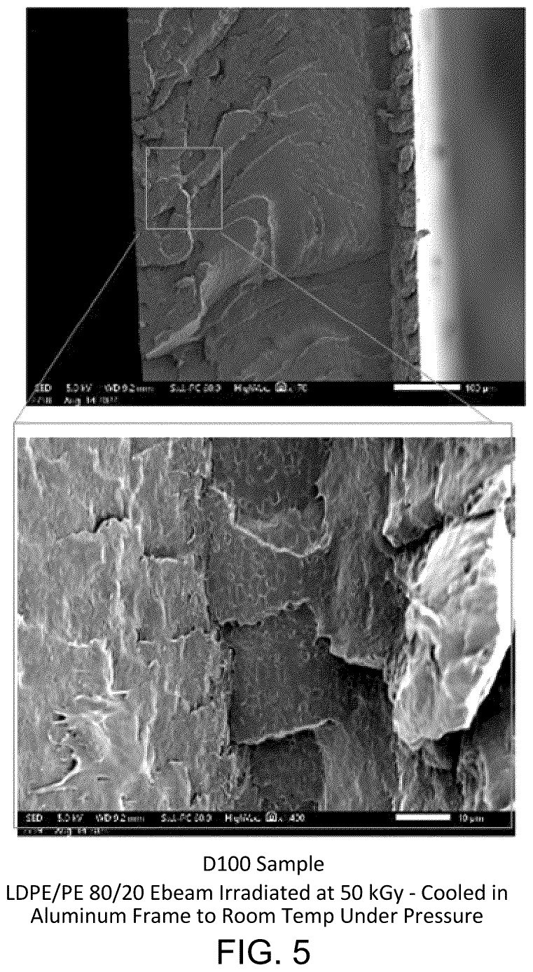

FIG. 5 are images of the D100 sample of the material of Example 1.

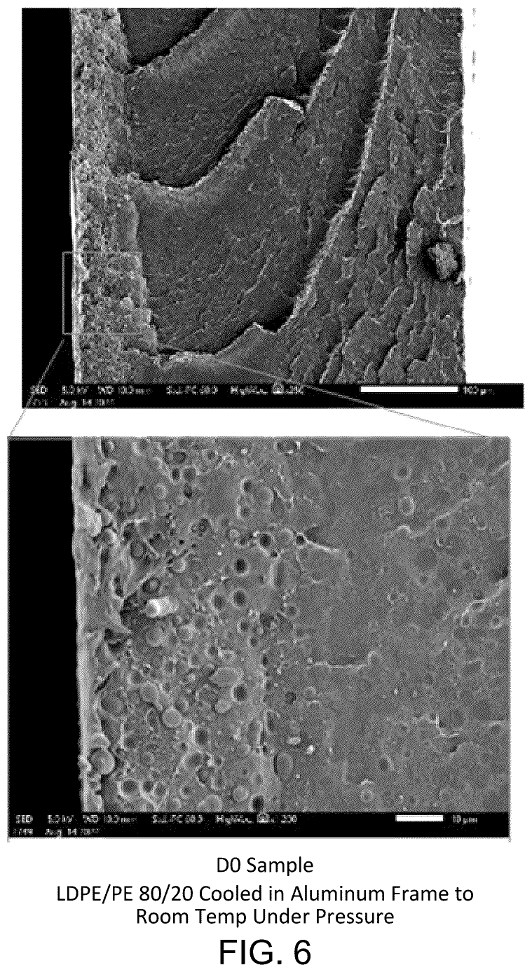

FIG. 6 are images of the same material as that of Example 1, except that the material of FIG. 6 was not irradiated with electron beam radiation.

In one novel aspect, an amount of PE material is obtained at least in part from previously used finished consumer articles. The term finished consumer article as it is used here is a general term that refers to recyclable items including household articles including containers and bottles and bags, and packaging, carpets, pipe, and further including industrial and building and construction items, and further including agricultural coverings. This amount of material, referred to as PE material, may actually be accompanied by small amounts of other materials as is commonly found in recycled garbage articles made primarily of PE. The PE in the PE materials may be largely LDPE or HDPE. This obtaining step may involve purchasing and thereby acquiring recycled plastic PE material garbage and has been crudely sorted and flaked and crudely washed so that it is thought to be primarily and almost entirely PE.

Also, an amount of PP is obtained at least in part from previously used finished consumer articles. This amount of material, referred to as PP material, may actually be accompanied by small amounts of other materials as is commonly found in recycled articles made primarily of PP. This obtaining step may involve purchasing and thereby acquiring recycled plastic PP garbage and has been crudely sorted and flaked and crudely washed so that it is thought to be primarily and almost entirely PP.

A ratio of the amounts of the PE and PP materials is then combined into a composite material (so that the composite material includes, for example, 80 percent polyethylene and 20 percent polypropylene), for example by passing the amounts through an extruder, and the output of the extruder is then preferably pelletized. Care is taken to keep the weight percent of the PP constituent in the composite material at less than 30 percent, and at least 95 percent by weight of the composite material is due to the PP and PE constituents. The pellets are standard cylindrical pellets that have a diameter of about 3 mm and a length of 4 mm.

Next, the resulting composite material (for example, in pellet form) is irradiated (for example, as pellets in the solid state) with electron beam radiation (for example, at an energy of 2.0-3.5 MeV at a total dose of ≤50 kGy) so as to promote degradation and cross-linking. In an alternative, rather than the composite material being in pellet form at the time of irradiation, the composite material may be in another form, such as in sheet form in the solid state. The irradiation causes degradation of polypropylene, as well as a reduction in the dispersed phase polyethylene, and the creation of complex new cross-linked polymer molecules that are neither polypropylene nor polyethylene. After irradiation, the resulting irradiated material is optionally then anneal heated and then cooled again back down to room temperature under a pressure higher than atmospheric pressure. The resulting irradiated and optionally annealed material, referred to here as “Super PE” material, is in pellet form. The resulting Super PE material may then be sold in this pelletized form for subsequent use in making plastic articles.

In one example, the Super PE material has the following properties and characteristics:

Super PE Material

| PP | ≤30% by weight (prior to irradiation) |
|---|---|
| PE (for example, LDPE) | ≤90% by weight (prior to irradiation) |
| PP and PE combined | ≥95% by weight (prior to irradiation) |
| Compatibilizer | Substantially zero (0% by weight) |
| Electron Beam Irradiation | ≤50 kGy (25-50 kGy) total dosage |
| CV (Complex Viscosity) | ≤6000 Pa · s@230° C. at 1 Hz |
| E (Modulus of Elasticity) | ≥300 MPa |
| [symbol] (Ultimate Stress at Failure) | ≥15 MPa |
| [symbol] (Ultimate Strain at Failure) | ≥600% |
| Gel Fraction | ≤20% |

Importantly, the “Super PE” material is made from PE and PP obtained from recycled garbage articles, is very flowable having a complex viscosity of ≤ 6000 Pa·s@230° C. at 1 Hz, while at the same time it also has superior mechanical properties in terms of modulus of elasticity, ultimate stress at failure, and ultimate strain at failure. Although the Super PE material of Example 1 described above includes substantially zero compatibilizer by weight, the material in other examples has the same starting materials as Example 1 and is processed in the same way as Example 1, with the only difference being the presence of some compatibilizer in the starting blend. In most examples of the “Super PE” material, the composite material before irradiation includes amounts of other materials other than polypropylene and polyethylene and polyethylene terephthalate (PET) due to the composite material being made from a mix of garbage recycled finished consumer articles, such that the composite material includes trace and residual amounts of polymer and non-polymer materials and contaminants.

FIG. 7 is a simplified diagram of the molecular structure of Polyethylene terephthalate (PET). In another embodiment, a blend of PP and PET is made, and extruded, and then the resulting sheet of extruded material is irradiated with electron beam radiation (for example, at a dose of 50 kGy). The resulting material is pelletized, and is sold in pelletized form for subsequent use in making plastic articles. In another embodiment, a blend of LDPE and PET is made, and extruded, and then the resulting sheet of extruded material is irradiated with electron beam radiation (for example, at a dose of 50 kGy). The resulting material is pelletized, and is sold in pelletized form for subsequent use in making plastic articles.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A method comprising:
(a) obtaining an amount of polyethylene (PE) material, wherein the amount of PE material comprises a least some polyethylene that was part of a finished customer article;
(b) obtaining an amount of polypropylene (PP) material, wherein the amount of PP material comprises a least some polypropylene that was part of a finished customer article;
(c) making a blend that comprises the amount of PE material and the amount of PP material, wherein the blend is at least 95 percent by weight polyethylene and polypropylene, and wherein the blend is less than 30 percent by weight polypropylene; and
(d) electron beam irradiating the blend in the solid phase at a total dose of at least 25 kGy and less than 50 kGy thereby making a partially cross-linked material, wherein the partially cross-linked material has a complex viscosity of less than or equal to 6000 Pa·s@230 degrees Celsius at 1 Hz, has a modulus of rigidity of at least 300 MPa, has an ultimate stress at failure of at least 15 MPa, and has an ultimate strain at failure of at least 600%, and wherein the gel fraction of the partially cross-linked material is not more than 20 percent.

2. The method of claim 1, wherein the obtaining of (a) and the obtaining of (b) are different steps that occur at different times, and wherein the amount of polyethylene (PE) material obtained in (a) is an amount of material that is not obtained simultaneously with the amount of polypropylene (PP) material, and wherein the blending of (c) occurs after then obtaining of (a) and the obtaining of (b).

3. The method of claim 2, wherein (c) includes pelletizing the blend into pellets, and wherein (d) involves electron beam irradiating the blend when the blend is in the form of pellets.

4. The method of claim 1, wherein (d) includes anneal heating the blend after the blend has been irradiated and then cooling the blend.

5. The method of claim 1, wherein (d) includes anneal heating the blend after the blend has been irradiated and then cooling the blend under a pressure higher than atmospheric pressure.

6. The method of claim 1, wherein the partially cross-linked material after the electron beam irradiating in (d) is in the form of pellets.

7. The method of claim 1, wherein the blend at the time of the electron beam irradiating in (d) comprises substantially no compatibilizer.

8. The method of claim 1, wherein the blend prior to the electron beam irradiating in (d) further comprises an amount of polyethylene terephthalate (PET) material.

9. A partially cross-linked polymer material that comprises an amount of polypropylene, an amount of polyethylene, and substantially no compatibilizer, wherein the amount of polypropylene in the partially cross-linked polymer material is less than 30 percent by weight, wherein the combined amount of polyethylene and polypropylene in the partially cross-linked polymer material is at least 95 percent by weight, wherein the partially cross-linked polymer material has a complex viscosity of less than or equal to 6000 Pas@@230 degrees Celsius at 1 Hz, a modulus of rigidity of at least 300 MPa, an ultimate stress at failure of at least 15 MPa, an ultimate strain at failure of at least 600%, and a gel fraction of not more than 20 percent.
